(19) United States
(12) Patent Application Publication
(10) Pub. No.: US 2009/0093392 A1
(43) Pub. Date: Apr. 9, 2009

(54) Detergent Compositions and Their Use

(75) Inventors: David Alan Binder, Saddle Brook, NJ (US); Petrus Wilhelmus N de Groot, Vlaardingen (NL); Donna MacNab, Bebington (GB); Albert van der Wal, Vaardingen (NL)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC. D/B/A/ UNILEVER, Englewood Cliffs, NJ (US)

(21) Appl. No.: 11/920,783

(22) PCT Filed: Apr. 20, 2006
(86) PCT No.: PCT/EP2006/003792

§ 371 Date: Jul. 17, 2008

(30) Foreign Application Priority Data
May 28, 2005 (GB) 0510989.7

(51) Int. Cl. C11D 3/30

(52) U.S. Cl. 510/299

(57) ABSTRACT

Use of a detergent composition comprising an amine oxide surfactant, at least one branched nonionic surfactant and at least one anionic component for enhancing particulate soil removal from a fabric washed in a wash liquor containing the detergent composition.

### TECHNICAL FIELD

This invention relates to detergent compositions and use thereof, for enhancing particulate soil removal in the wash.

### BACKGROUND TO THE INVENTION

The detergent compositions employed in the present invention employ an amine oxide component. Amine oxide surfactants have been used in combination with alkyl sulphate anionic surfactants in detergent compositions, particularly aqueous liquid detergent compositions, for the purpose of replacing linear alkylbenzene sulphonate anionic surfactants, as described in U.S. Pat. No. 5,981,466. They have been used in combination with ethoxylated alkyl sulphate anionic surfactants in liquid hand dishwashing compositions according to the disclosure of U.S. Pat. No. 6,294,514.

We have now found that amine oxides are particularly useful as components of detergent compositions for the purposes of removing particulate soil.

### DEFINITION OF THE INVENTION

In a first aspect, the present invention provides use of a detergent composition comprising an amine oxide surfactant, at least one branched nonionic surfactant and at least one anionic component for enhancing particulate soil removal from a fabric washed in a wash liquor containing the detergent composition.

A second aspect of the present invention provides a detergent composition comprising an amine oxide surfactant, at least one branched nonionic surfactant and at least one fatty acid or salt thereof having at least 17 carbon atoms.

### DETAILED DESCRIPTION OF THE INVENTION

The present invention involves detergent compositions which may be in any suitable physical form, such as powders, tablets, liquid (including substantially aqueous and substantially non-aqueous liquid) and gel compositions, including any of these provided in encapsulated (eg in-pouch) form. However, the liquid detergents, especially the substantially aqueous liquid detergents, are especially preferred. Further details of such product forms are described in more detail hereinbelow.

### The Amine Oxide Surfactant

The amine oxide surfactant may comprise one or more surfactants of the amine oxide type, for example having the general formula (I):—

R¹R²(N)R³→0 (I)

wherein R¹ and R² are independently C₁-C₄ alkyl or hydroxy-C₁-C₄ alkyl groups and R³ is a C₈ to C₁₈ alkyl or alkenyl group.

The inclusion rate of amine oxide surfactant is preferably from 0.1% to 10%, more preferably from 0.5% to 5% by weight of the total composition.

### The Anionic Component

For use according to the present invention, the anionic component may for example be selected from anionic detersive surfactants, fatty acids, salts or fatty acids and mixtures thereof. A preferred form of such fatty acids and their salts for use according to the first aspect of the present invention but essential for detergent compositions according to the second aspect of the invention, are those which have at least 17 carbon atoms per molecule. Of these, especially preferred are the saturated or monounsaturated C₁₇-C₁₈ fatty acids and their salts. The most preferred examples of these are oleic and isostearic acids and their salts.

Preferred salts are the soaps comprising the alkali metal (eg sodium or potassium) or the calcium salts.

Preferred detersive surfactants for use as anionic components in either the first or second aspects of the present invention are the (poly)alkoxylated alkyl sulphate surfactants, especially the ethoxylated sulphates having from 1 to 3 ethyleneoxide in it per molecule.

A preferred inclusion rate for the anionic component is from 0.5% to 60% (depending on the product form) by weight of the total composition, more preferably from 1% to 35%, more preferably from 2% to 30%, especially from 3% to 20% by weight. In the case of the fatty acids and their salts, especially C₁₇-C₁₈ fatty acids and their salts, a preferred inclusion rate is from 0.5% to 15%, preferably from 1% to 10% by weight of the composition. A preferred inclusion rate for the (poly)alkoxylated sulphates is from 0.5 to 10%, more preferably from 1 to 7% by weight of the composition.

### Nonionic Surfactants

Branched nonionic surfactants are also included. The amount of these materials, in total, is preferably from 0.01% to 50%, preferably from 0.1% to 35%, more preferably from 0.5% to 25%, still more preferably from 0.7% to 20%, even more preferably from 0.8% to 15%, especially from 1% to 10% and even more especially from 1% to 7% by weight of the composition.

Preferred nonionic surfactants are aliphatic alcohols having an average degree of ethoxylation of from 2 to 12, more preferably from 3 to 10. Preferably, the aliphatic alcohols are C₈-C₁₆, more preferably C₁₀-C₁₅. The mid-chain branched hydrophobe nonionics disclosed in WO-A-98/23712 are a preferred class of these.

Suitable other non-ethoxylated nonionic surfactants include alkylpolyglycosides, glycerol monoethers, and polyhydroxyamides (glucamide).

### Cosurfactants

Compositions used in accordance with the invention may contain not only the amine oxide surfactant and the anionic component such as (poly)alkoxylated alkyl sulphates and/or the fatty acids and/or fatty salts having at least 17 carbon atoms but potentially any one or more other surface-active compound (surfactant) which may be chosen from other soap and other non-soap anionic surfactants, cationic, non-ionic, amphoteric and zwitterionic surface-active compounds and mixtures thereof. Many suitable surface-active compounds are available and are fully described in the literature, for example, in “Surface-Active Agents and Detergents”, Volumes I and II, by Schwartz, Perry and Berch.

### Other Anionic Surfactant

The (poly)alkoxylated alkyl sulphates and/or fatty acids or salts thereof having at least 17 carbon atoms surfactant are preferable anionic components for use according to the first aspect of the invention but are essential for compositions according to the second aspect of the invention. However, at least one other anionic co-surfactant is optionally also present. It may for example be selected from one or more of alkylbenzene sulphonates, alkyl sulphonates, primary and secondary alkyl sulphates (in free acid and/or salt forms).

A solid detergent composition according to the present invention may, for example, contain from 0.1% to 50%, preferably from 1% to 30%, more preferably from 2% to 25%, especially from 3% to 20% by weight of alkylbenzene sulphonate surfactant.

A liquid detergent composition according to the present invention may, for example contain from 0.1% to 20%, preferably from 1% to 15%, more preferably from 2% to 10% by weight, of alkylbenzene sulphonic surfactant (in free acid and/or salt form).

### Soaps

Optionally, a soap other than a soap having at least 17 carbon atoms may also be used. In the widest sense, soaps include those having a chain length ranging from C₁₂ to C₂₀, mainly saturated, and optionally containing limited levels of 1 or 2 unsaturated bonds, and derived from natural oils and fats such as for example: (hardened or non-hardened) Tallow, Coconut, or Palm Kernel.

### Optional Other Surfactants

Optional other surfactants include additional nonionic surfactants, cationic surfactants (for detergency enhancement and/or fabric softening), amphoteric and zwitterionic surfactants.

If desired, additional nonionic surfactant may be included. The amount of these materials, in total, is preferably from 0.01% to 50%, preferably from 0.1% to 35%, more preferably from 0.5% to 25%, still more preferably from 0.7% to 20%, even more preferably from 0.8% to 15%, especially from 1% to 10% and even more especially from 1% to 7% by weight of the composition. Branched nonionic surfactants are especially preferred.

Preferred nonionic surfactants are aliphatic alcohols having an average degree of ethoxylation of from 2 to 12, more preferably from 3 to 10. Preferably, the aliphatic alcohols are C₈-C₁₆, more preferably C₁₀-C₁₅. The mid-chain branched hydrophobe nonionics disclosed in WO-A-98/23712 are a preferred class of these.

Suitable other non-ethoxylated nonionic surfactants include alkylpolyglycosides, glycerol monoethers, and polyhydroxyamides (glucamide).

Optionally, a composition according to the present invention may comprise from 0.05% to 10%, preferably from 0.1% to 5%, more preferably from 0.25% to 2.5%, especially from 0.5% to 1% by weight of cationic surfactant.

Suitable cationic fabric softening compounds are substantially water-insoluble quaternary ammonium materials comprising a single alkyl or alkenyl long chain having an average chain length greater than or equal to C₂₀ or, more preferably, compounds comprising a polar head group and two alkyl or alkenyl chains having an average chain length greater than or equal to C₁₄. Preferably the fabric softening compounds have two long chain alkyl or alkenyl chains each having an average chain length greater than or equal to C₁₆. Most preferably at least 50% of the long chain alkyl or alkenyl groups have a chain length of C₁₈ or above. It is preferred if the long chain alkyl or alkenyl groups of the fabric softening compound are predominantly linear.

Quaternary ammonium compounds having two long-chain aliphatic groups, for example, distearyldimethyl ammonium chloride and di(hardened tallow alkyl) dimethyl ammonium chloride, are widely used in commercially available rinse conditioner compositions. Other examples of these cationic compounds are to be found in “Surfactants Science Series” volume 34 ed. Richmond 1990, volume 37 ed. Rubingh 1991 and volume 53 eds. Cross and Singer 1994, Marcel Dekker Inc. New York”.

It is also possible to include certain mono-alkyl cationic surfactants which can be used for their detergency. Cationic surfactants that may be used for this purpose include quaternary ammonium salts of the general formula R₁R₂R₃R₄N⁺ X⁻ wherein the R groups are long or short hydrocarbon chains, typically alkyl, hydroxyalkyl or ethoxylated alkyl groups, and X is a counter-ion (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters).

### Detergency Builders

The compositions of the invention will quite often also contain one or more detergency builders. The total amount of detergency builder in the compositions will typically range from 1% to 80 wt %, preferably from 2% to 60 wt %, more preferably from 4% to 30% by weight of the total composition.

Inorganic builders that may be present include sodium carbonate, if desired in combination with a crystallisation seed for calcium carbonate, as disclosed in GB-A-1 437 950; crystalline and amorphous aluminosilicates, for example, zeolites as disclosed in GB-A-1 473 201, amorphous aluminosilicates as disclosed in GB-A-1 473 202 and mixed crystalline/amorphous aluminosilicates as disclosed in GB-A-1 470 250; and layered silicates as disclosed in EP-A-164 514. Inorganic phosphate builders, for example, sodium orthophosphate, sodium pyrophosphate and sodium tripolyphosphate (STP) are also suitable for use with this invention.

The compositions of the invention preferably contain an alkali metal, preferably sodium, aluminosilicate builder. Sodium aluminosilicates may generally be incorporated in amounts of from 10 to 70% by weight (anhydrous basis), preferably from 20 to 50 wt %.

When the aluminosilicate is zeolite, preferably the maximum amount is 30% by weight.

The alkali metal aluminosilicate may be either crystalline or amorphous or mixtures thereof, having the general formula: 0.8-1.5 Na₂O. Al₂O₃. 0.8-6 SiO₂.

These materials contain some bound water and are required to have a calcium ion exchange capacity of at least 50 mg Ca/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature. Suitable crystalline sodium aluminosilicate ion-exchange detergency builders are described, for example, in GB-A-1 429 143. The preferred sodium aluminosilicates of this type are the well-known commercially available zeolites A and X, and mixtures thereof.

The zeolite may be the commercially available zeolite 4A now widely used in laundry detergent powders. However, according to a preferred embodiment of the invention, the zeolite builder incorporated in the compositions of the invention is maximum aluminium zeolite P (zeolite MAP) as described and claimed in EP-A-384 070. Zeolite MAP is defined as an alkali metal aluminosilicate of the zeolite P type having a silicon to aluminium ratio not exceeding 1.33, preferably within the range of from 0.90 to 1.33, and more preferably within the range of from 0.90 to 1.20.

Especially preferred is zeolite MAP having a silicon to aluminium ratio not exceeding 1.07, more preferably about 1.00. The calcium binding capacity of zeolite MAP is generally equivalent to at least 150 mg CaO per g of anhydrous material.

Organic builders that may be present include polycarboxylate polymers such as polyacrylates, acrylic/maleic copolymers, and acrylic phosphinates; monomeric polycarboxylates such as citrates, gluconates, oxydisuccinates, glycerol mono-, di and trisuccinates, carboxymethyloxy succinates, carboxymethyloxymalonates, dipicolinates, hydroxyethyliminodiacetates, alkyl- and alkenylmalonates and succinates; and sulphonated fatty acid salts. This list is not intended to be exhaustive.

Especially preferred organic builders are citrates, suitably used in amounts of from 2 to 30 wt %, preferably from 5 to 25 wt %; and acrylic polymers, more especially acrylic/maleic copolymers, suitably used in amounts of from 0.5 to 15 wt %, preferably from 1 to 10 wt %. These are especially useful in liquid detergent compositions according to the invention.

Builders, both inorganic and organic, are preferably present in alkali metal salt, especially sodium salt, form.

### Bleaches

Compositions according to the invention may also suitably contain a bleach system. Fabric washing compositions may desirably contain peroxygen bleaching agents and precursors thereof, for example, inorganic persalts or organic peroxyacids, capable of yielding hydrogen peroxide in aqueous solution.

Peroxygen bleaching agents include those peroxygen bleaching compounds which are capable of yielding hydrogen peroxide in an aqueous solution. These compounds are well known in the art and include hydrogen peroxide and the alkali metal peroxides, organic peroxide bleaching compounds such as urea peroxide, and inorganic persalt bleaching compounds, such as the alkali metal perborates, percarbonates, perphosphates, and the like. Mixtures of two or more such compounds may also be suitable.

Preferred peroxygen bleaching agents include peroxygen bleach selected from the group consisting of perborates, percarbonates, peroxyhydrates, peroxides, persulfates, and mixtures thereof. Specific preferred examples include: sodium perborate, commercially available in the form of mono- and tetra-hydrates, sodium carbonate peroxyhydrate, sodium pyrophosphate peroxyhydrate, urea peroxyhydrate, and sodium peroxide. Particular preferred are sodium perborate tetrahydrate, and especially, sodium perborate monohydrate. Sodium perborate monohydrate is especially preferred because it is very stable during storage and yet still dissolves very quickly in the bleaching solution. Sodium percarbonate may also be preferred for environmental reasons.

The amount thereof in the composition of the invention usually will be within the range of about 1-35% by weight, preferably from 5-25% by weight. One skilled in the art will appreciate that these amounts may be reduced in the presence of a bleach precursor e.g., N,N,N′N′-tetraacetyl ethylene diamine (TAED).

Another suitable hydrogen peroxide generating system is a combination of a C1-C4 alkanol oxidase and a C1-C4 alkanol, especially a combination of methanol oxidase (MOX) and ethanol or glucose oxidase (GOX) and glucose. Such combinations are disclosed in International Application PCT/EP 94/03003 and WO9856885 (Unilever), which is incorporated herein by reference.

Alkylhydroperoxides are another class of peroxy bleaching compounds. Examples of these materials include cumene hydroperoxide, t-butylhydroperoxide and hydroperoxides originated from unsaturated compounds, such as unsaturated soaps

Further, useful compounds as oxygen bleaches include superoxide salts, such as potassium superoxide, or peroxide salts, such as disodiumperoxide, calcium peroxide or magnesium peroxide.

Organic peroxyacids may also be suitable as the peroxy bleaching compound. Such materials normally have the general formula:

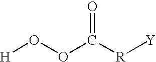

wherein R is an alkylene or substituted alkylene group containing from 1 to about 20 carbon atoms, optionally having an internal amide linkage; or a phenylene or substituted phenylene group; and Y is hydrogen, halogen, alkyl, aryl, an imido-aromatic or non-aromatic group, a COOH or

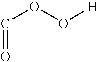

group (giving di(peroxyacids)) or a quaternary ammonium group.

Typical monoperoxy acids useful herein include, for example:

(i) peroxybenzoic acid and ring-substituted peroxybenzoic acids, e.g. peroxy-.alpha.-naphthoic acid or m-chloroperoxybenzoic acid
(ii) aliphatic, substituted aliphatic and arylalkyl monoperoxyacids, e.g. peroxylauric acid, peroxystearic acid, 4-nonylamino-4-oxoperoxybutyric acid, and N,N-phthaloylaminoperoxy caproic acid (PAP); and
(iii) 6-octylamino-6-oxo-caproic acid.
(iv) magnesium monoperoxophtalate hexahydrate, available from Interox.
(v) 6-nonylamino-6-oxoperoxycaproic acid (NAPAA)
(vi) Phtaloylimidoperoxycaproic acid

Typical diperoxyacids useful herein include, for example:

(vii) 1,12-diperoxydodecanedioic acid (DPDA);
(vii) 1,9-diperoxyazelaic acid;
(viii) diperoxytetradecanedioc acid
(ix) diperoxyhexadecanedioc acid
(x) diperoxybrassilic acid; diperoxysebasic acid and diperoxyisophthalic acid;
(xi) 2-decyldiperoxybutane-1,4-diotic acid; and
(xii) 4,4′-sulphonylbisperoxybenzoic acid.

Also inorganic peroxyacid compounds are suitable, such as for example potassium monopersulphate (MPS). If organic or inorganic peroxyacids are used as the peroxygen compound, the amount thereof will normally be within the range of about 2-10% by weight, preferably from 4-8% by weight.

Peroxyacid bleach precursors are known and amply described in literature, such as in the British Patents 836988; 864,798; 907,356; 1,003,310 and 1,519,351; German Patent 3,337,921; EP-A-0185522; EP-A-0174132; EP-A-0120591; and U.S. Pat. Nos. 1,246,339; 3,332,882; 4,128,494; 4,412,934 and 4,675,393.

Another useful class of peroxyacid bleach precursors is that of the cationic i.e. quaternary ammonium substituted peroxyacid precursors as disclosed in U.S. Pat. Nos. 4,751,015 and 4,397,757, in EP-A0284292 and EP-A-331,229. Examples of peroxyacid bleach precursors of this class are:
2-(N,N,N-trimethyl ammonium) ethyl-4-sulphonylcarbonate (CSPC); as disclosed in U.S. Pat. No. 4,751,015;
N-octyl-N,N-dimethyl-N10-carbophenoxy decyl ammonium chloride (ODC);
and N,N,N-trimethyl ammonium toluyloxy benzene sulphonate.

A further special class of bleach precursors is formed by the cationic nitriles as disclosed in EP-A-303,520 and in European Patent Specification Nos. EP-A-458,396 and EP-A-464,880.

Any one of these peroxyacid bleach precursors can be used in the present invention, though some may be more preferred than others.

Of the above classes of bleach precursors, the preferred classes are the esters, including acyl phenol sulphonates and acyl alkyl phenol sulphonates; the acyl-amides; and the quaternary ammonium substituted peroxyacid precursors including the cationic nitriles.

Examples of said preferred peroxyacid bleach precursors or activators are sodium-4-benzoyloxy benzene sulphonate (SBOBS); N,N,N′N′-tetraacetyl ethylene diamine (TAED); sodium-1-methyl-2-benzoyloxy benzene-4-sulphonate; sodium-4-methyl-3-benzoloxy benzoate; SSPC; trimethyl ammonium toluyloxy-benzene sulphonate; sodium nonanoyloxybenzene sulphonate (SNOBS); sodium 3,5,5-trimethyl hexanoyl-oxybenzene sulphonate (STHOBS); and the substituted cationic nitriles.

Each of the above precursor may be applied in mixtures, eg combination of TAED (hydrophylic precursor) with more hydrophobic precursor, such as sodium nonanoyloxybenzene sulphonate.

Alternatively, one may apply aromatic aldehydes and dioxygen as peroxy acid precursor, as disclosed in WO97/38074.

The precursors may be used in an amount of up to 12%, preferably from 2-10% by weight, of the composition.

Other classes of bleach precursors for use with the present invention are found in WO0015750 and WO9428104, for example 6-(nonanamidocaproyl)oxybenzene sulphonate. See WO0002990 for cylic imido bleach activators.

The precursors may be used in an amount of up to 12%, preferably from 2-10% by weight, of the composition.

The bleaching composition of the present invention has particular application in detergent formulations, especially for laundry cleaning. Accordingly, in another preferred embodiment, the present invention provides a detergent bleach composition comprising a bleaching composition as defined above and additionally a surface-active material, optionally together with detergency builder.

Also useful as bleaching agents in the compositions according to any aspect of the present invention are any of the known organic bleach catalysts, oxygen transfer agents or precursors therefor. These include the compounds themselves and/or their precursors, for example any suitable ketone for production of dioxiranes and/or any of the heteroatom containing analogs of dioxirane precursors or dioxiranes, such as sulfonimines R1R2C═NS02R3 (EP 446 982 A) and sulfonyloxaziridines, for example:

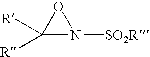

EP 446,981 A. Preferred examples of such materials include hydrophilic or hydrophobic ketones, used especially in conjunction with monoperoxysulfates to produce dioxiranes in situ, and/or the imines described in U.S. Pat. No. 5,576,282 and references described therein. Oxygen bleaches preferably used in conjunction with such oxygen transfer agents or precursors include percarboxylic acids and salts, percarbonic acids and salts, peroxymonosulfuric acid and salts, and mixtures thereof. See also U.S. Pat. No. 5,360,568; U.S. Pat. No. 5,360,569; U.S. 5,370,826; and 5,710,116.

Transition-metal bleach catalysts are well-known in the art. Various classes have been disclosed based on especially cobalt, manganese, iron and copper transition-metal complexes. Most of these bleach catalysts are claimed to yield hydrogen peroxide or peroxyacid activation, certain classes of compounds are also disclosed to give stain bleaching by atmospheric oxygen.

One type of manganese-containing bleach catalysts include the manganese-based complexes disclosed in U.S. Pat. No. 5,246,621 and U.S. Pat. No. 5,244,594. Preferred examples of theses catalysts include [Mn^{IV}₂(μ-O)₃(1,4,7-trimethyl-1,4,7-triazacyclononane)₂] (PF₆)₂, [Mn^{III}₂(μ-O) (μ-OAc)₂(1,4,7-trimethyl-1,4,7-triazacyclononane)₂] (ClO₄)₂, [Mn^{IV}₄(μ-O)₆(1,4,7-triazacyclononane)₄] (ClO₄)₂, Mn^{III}Mn_{IV}(μ-O) (μ-OAc)₂(1,4,7-trimethyl-1,4,7-triazacyclononane)₂] (ClO₄)₃, and mixtures thereof. See also European patent application publication no. 549,272. Other ligands suitable for use herein include 1,5,9-trimethyl-1,5,9-triazacyclododecane, 2-methyl-1,4,7-triazacyclononane, 2-methyl-1,4,7-trimethyl-1,4,7-triazacyclononane, and mixtures thereof. See also U.S. Pat. No. 5,194,416 which teaches mononuclear manganese (IV) complexes such as [Mn(1,4,7-trimethyl-1,4,7-triazacyclononane) (OCH₃)₃] (PF₆). Patent applications EP0549271; DE19738273 teach the use of free ligand 1,4,7-trimethyl-1,4,7-triazacyclononane in detergent formulations. A dinuclear manganese compound, [LMn^{III}Mn^{IV}(μ-O) (μ-OAc)₂] (ClO₄)₂ with L being an ethylene-bridged-bis(1,4-dimethyl-1,4,7-triazacyclononane) ligands has been disclosed in WO 9606154.

Still another type of bleach catalyst, as disclosed in U.S. Pat. No. 5,114,606, is a water-soluble complex of manganese (II), (III), and/or (IV) with a ligand which is a non-carboxylate polyhydroxy compound having at least three consecutive C—OH groups. Preferred ligands include sorbitol, iditol, dulsitol, mannitol, xylitol, arabitol, adonitol, meso-erythritol, meso-inositol, lactose, and mixtures thereof.

U.S. Pat. No. 5,114,611 teaches another useful bleach catalyst comprising a complex of transition metals, including Mn, Co, Fe, or Cu, with an non-(macro)-cyclic ligand. Preferred ligands include pyridine, pyridazine, pyrimidine, pyrazine, imidazole, pyrazole, and triazole rings. Optionally, said rings may be substituted with substituents such as alkyl, aryl, alkoxy, halide, and nitro. Particularly preferred is the ligand 2,2′-bispyridylamine. Preferred bleach catalysts include Co—, Cu—, Mn—, or Fe-bispyridylmethane and bispyridylamine complexes. Highly preferred catalysts include Co(2,2′-bispyridylamine)Cl₂, Di(isothiocyanato)bispyridylamine-cobalt(II), trisdipyridylamine-cobalt(II) perchlorate, [Co(2,2-bispyridylamine)₂O₂]ClO₄, Bis-(2,2′-bispyridylamine)copper(II) perchlorate, tris(di-2-pyridylamine) iron(II) perchlorate, and mixtures thereof.

Various manganese and iron complexes containing (pyridin-2ylmethyl)amine moieties as bleach catalysts are disclosed in DE19755493, EP0783035, U.S. Pat. No. 5,850,086, EP0782998, EP0782999, WO9748787, WO9730144, WO0027975, WO0027976, WO0012667, and WO0012668. Preferred ligands include bis(CH₂COOH) (pyridin-2-ylmethyl)amine, tris(pyridin-2ylmethyl)amine, bis(pyridin-2-ylmethylamine), N,N,N′,N′-tetrakis(pyridin-2ylmethyl)-ethylenediamine, N,N,N′,N′-tetrakis(benzimidazol-2ylmethyl)-propan-2-ol, N-methyl-N,N′,N′-tris(3-methyl-pyridin-2ylmethyl)-ethylenediamine, N-methyl-N,N′,N′-tris(5-methyl-pyridin-2ylmethyl)-ethylenediamine, N-methyl-N,N′,N′-tris(3-ethyl-pyridin-2ylmethyl)-ethylenediamine, N-methyl-N,N′,N′-tris(3-methyl-pyridin-2ylmethyl)-ethylenediamine.

A series of patent applications deal with iron complexes containing the bis(pyridin-2yl)methyl-amine moiety both for peroxy bleaching activation and atmospheric air bleaching of stains, i.e. WO9534628, EP0909809, WO0060044, WO0032731, WO0012667, and WO0012668, wherein the iron complexes containing N,N-bis(pyridin-2-yl-methyl)-1,1-bis(pyridin-2-yl)-1-aminoethane are often the most preferred catalysts.

Manganese complexes containing 1,10-phenanthroline and 2,2′-bipyridine as bleaching catalysts have been disclosed in WO9615136 and WO9964554.

Manganese complexes with Schiff-base ligands to bleach stains or dyes in solution have been disclosed in various patent applications (GB-A-2 325 001, WO-A-00/53708, EP-A-896 171 WO-A-97/44430, WO-A-97/07191, and WO-A-97/07192).

Another preferred class of manganese complexes include mononuclear manganese complexes containing cross-bridged macrocyclic ligands. These complexes have been claimed with peroxy compounds and without peroxy compounds present in the formulation (WO-A-98/39098, WO-A-98/39405 and WO-A-00/29537). The most preferred complexes include dichloro-5,12-dimethyl-1,5,8,12-tetraazabicyclo[6.6.2]hexadecane Manganese(II) and dichloro-4,10-dimethyl-1,4,7,10-tetraazabicyclo[5.5.2]tetradecane Manganese(II).

Further a class of manganese complexes containing bispidon as ligand has been disclosed as a family of bleach catalysts in the presence and absence of peroxy compounds (WO0060045), wherein dimethyl 2,4-di-(2-pyridyl)-3,7-dimethyl-3,7-diaza-bicyclo[3.3.1]nonan-9one-1,5-dicarboxylate is the preferred ligand.

Other bleach catalysts are described, for example, in European patent application, publication no. EP-A-0 408,131 (dinuclear cobalt Schiff-base complex catalysts), European patent applications, publication nos. EP-A-384,503, and EP-A-306,089 (metallo-porphyrin catalysts), U.S. Pat. No. 4,711,748 and European patent application, publication EP-A-224,952, (absorbed manganese on aluminosilicate catalyst), U.S.-A-4,601,845 (aluminosilicate support with manganese and zinc or magnesium salt), U.S. Pat. No. 4,626,373 (manganese/ligand catalyst), U.S. Pat. No. 4,119,557 (ferric complex catalyst), German Pat. specification DE-A-2,054,019 (cobalt-1,10-phenanthroline catalyst), Canadian 866,191 (transition metal-containing salts), U.S. Pat. No. 4,430,243 (chelants with manganese cations and non-catalytic metal cations), and U.S. Pat. No. 4,728,455 (manganese gluconate catalysts).

Another class of preferred cobalt catalysts having the formula [Co(NH₃)₅Cl]Cl₂ has been disclosed in EP-A-0 272 030. Yet another class of preferred of cobalt (III) catalysts [Co (NH₃)₅ (carboxylate)]X₂ (with X a non-coordinating anion), as disclosed in U.S. Pat. No. 580,001 and U.S. Pat. No. 508,198.

Inorganic polyoxometallates as bleaching/oxidation catalysts with peroxy bleaches and air have been claimed in various patent applications, i.e. WO-A-97/07886, WO-A-99/28426, DE-A-1 953 0786, and WO-A-00/39264.

The bleach catalysts may be used in an amount of up to 5%, preferably from 0.001-1% by weight, of the composition.

### Chelating Agents

The compositions according to the present invention may also optionally contain one or more heavy metal chelating agents. Generally, chelating agents suitable for use herein can be selected from the group consisting of aminocarboxylates, aminophosphonates, polyfunctionally-substituted aromatic chelating agents and mixtures thereof. Without intending to be bound by theory, it is believed that the benefit of these materials is due in part to their exceptional ability to remove heavy metal ions from washing solutions by formation of soluble chelates; other benefits include inorganic film or scale prevention. Other suitable chelating agents for use herein are the commercial DEQUEST series, and chelants from Monsanto, DuPont, and Nalco, Inc.

Aminocarboxylates useful as optional chelating agents include ethylenediaminetetracetates, N-hydroxyethylethylenediaminetriacetates, nitrilotriacetates, ethylenediamine tetraproprionates, triethylenetetraaminehexacetates, diethylenetriamine-pentaacetates, and ethanoldiglycines, alkali metal, ammonium, and substituted ammonium salts therein and mixtures therein.

Aminophosphonates are also suitable for use as chelating agents in the compositions of the invention when at least low levels of total phosphorus are permitted in detergent compositions, and include ethylenediaminetetrakis (methylenephosphonates). Preferably, these aminophosphonates do not contain alkyl or alkenyl groups with more than about 6 carbon atoms.

Polyfunctionally-substituted aromatic chelating agents are also useful in the compositions herein. See U.S. Pat. No. 3,812,044. Preferred compounds of this type in acid form are dihydroxydisulfobenzenes such as 1,2-dihydroxy-3,5-disulfobenzene.

A chelator for use herein is ethylenediamine disuccinate (“EDDS”), especially (but not limited to) the [S,S] isomer as described in U.S. Pat. No. 4,704,233. The trisodium salt is preferred though other forms, such as magnesium salts, may also be useful.

If utilized these chelating agents or transition-metal-selective sequestrants will preferably comprise from about 0.001% to about 10%, more preferably from about 0.05% to about 1% by weight of the bleaching compositions herein.

### Enzymes

Compositions according to the invention may also contain one or more enzyme(s). Suitable enzymes include the proteases, amylases, cellulases, oxidases, peroxidases and lipases usable for incorporation in detergent compositions. Preferred proteolytic enzymes (proteases) are, catalytically active protein materials which degrade or alter protein types of stains when present as in fabric stains in a hydrolysis reaction. They may be of any suitable origin, such as vegetable, animal, bacterial or yeast origin.

Proteolytic enzymes or proteases of various qualities and origins and having activity in various pH ranges of from 4-12 are available and can be used in the instant invention. Examples of suitable proteolytic enzymes are the subtilisins which are obtained from particular strains of B. Subtilis B. licheniformis, such as the commercially available subtilisins Maxatase (Trade Mark), as supplied by Gist Brocades N.V., Delft, Holland, and Alcalase (Trade Mark), as supplied by Novo Industri A/S, Copenhagen, Denmark.

Particularly suitable is a protease obtained from a strain of Bacillus having maximum activity throughout the pH range of 8-12, being commercially available, e.g. from Novo Industri A/S under the registered trade-names Esperase (Trade Mark) and Savinase (Trade-Mark). The preparation of these and analogous enzymes is described in GB-A-1 243 785. Other commercial proteases are Kazusase (Trade Mark obtainable from Showa-Denko of Japan), Optimase (Trade Mark from Miles Kali-Chemie, Hannover, West Germany), and Superase (Trade Mark obtainable from Pfizer of U.S.A.).

Detergency enzymes are commonly employed in granular form in amounts of from about 0.1 to about 3.0 wt %. However, any suitable physical form of enzyme may be used.

### Other Optional Minor Ingredients

As already mentioned, solid compositions of the invention may contain alkali metal, preferably sodium carbonate, in order to increase detergency and ease processing. Sodium carbonate may suitably be present in amounts ranging from 1 to 60 wt %, preferably from 2 to 40 wt %. However, compositions containing little or no sodium carbonate are also within the scope of the invention.

Powder flow may be improved by the incorporation of a small amount of a powder structurant, for example, a fatty acid (or fatty acid soap), a sugar, an acrylate or acrylate/maleate copolymer, or sodium silicate. One preferred powder structurant is fatty acid soap, suitably present in an amount of from 1 to 5 wt %.

Yet other materials that may be present in detergent compositions of the invention include sodium silicate; antiredeposition agents such as cellulosic polymers; inorganic salts such as sodium sulphate; lather control agents or lather boosters as appropriate; dyes; coloured speckles; perfumes; foam controllers; fluorescers and decoupling polymers. This list is not intended to be exhaustive.

### Product Form

Compositions of the present invention may for example be provided as solid compositions such as powders or tablets, or non-solid compositions such as substantially aqueous or substantially non-aqueous liquids, gels or pastes. In this context, aqueous means having more water than a substantially non-aqueous composition, for example preferably comprising at least 1%, more than 2%, more than 5%, preferably more than 10%, more preferably more than 15%, still more preferably more than 20%, yet more preferably more than 22%, most preferably more than 23% by weight of water. Optionally, liquid compositions may be provided in water soluble sachets. Non-solid, eg liquid, compositions may have different compositions from solid compositions and may for example comprise from 5% to 60%, preferably from 10% to 40% by weight of anionic surfactant (at least some of which will, of course, be aromaticalkyl sulphonic surfactant, from 2.5% to 60%, preferably from 5% to 35% by weight of nonionic surfactant and from 2% to 99% by weight of water. Optionally, liquid compositions may for example contain from 0.1% to 20%, preferably from 5% to 15% by weight of total soap.

Non-solid, eg liquid, compositions may also (subject to any exclusions or other provisos expressed herein in the context of any aspect of the invention), comprise one or more hydrotropes, especially when an isotropic composition is required. Such hydrotropes may, for example, be selected from arylsulphonates, eg benzene sulphonate, any of which is optionally independently substituted on the aryl ring or ring system by one or more C₁₋₆ eg C₁₋₄ alkyl groups, benzoic acid, salicylic acid, naphthoic acid, C₁₋₆, preferably C₁₋₄ polyglucosides, mono-, di- and triethanolamine. Where any of these compounds may exist in acid or salt (whether organic or inorganic, such as sodium), either may be used provided compatible with the remainder of the formulation.

### Preparation of the Compositions

The compositions of the invention may be prepared by any suitable process.

The choice of processing route may be in part dictated by the stability or heat-sensitivity of the surfactants involved, and the form in which they are available.

For granular products, ingredients such as enzymes, bleach ingredients, sequestrants, polymers and perfumes which are traditionally added separately (e.g. enzymes postdosed as granules, perfumes sprayed on) may be added after the processing steps outlined below.

Suitable processes include:

(1) drum drying of principal ingredients, optionally followed by granulation or postdosing of additional ingredients;
(2) non-tower granulation of all ingredients in a high-speed mixer/granulator, for example, a Fukae (Trade Mark) FS series mixer, preferably with at least one surfactant in paste form so that the water in the surfactant paste can act as a binder;
(3) non-tower granulation in a high speed/moderate speed granulator combination, thin film flash drier/evaporator or fluid bed granulator.

### EXAMPLES

Section 1: Addition of an amine oxide surfactant to an anionic containing composition

| | Wt % in formulation | | | | | |
|---|---|---|---|---|---|---|
| | (minors and water to 100%) | | | | | |
| | Exam- | Exam- | Exam- | Exam- | Exam- | Exam- |
| Ingredient | ple 1 | ple 2 | ple 3 | ple 4 | ple 5 | ple 6 |
| linear alkyl | 4.51 | 3 | 2.5 | 6.08 | 5.08 | 6.08 |
| benzene | | | | | | |
| sulphonate | | | | | | |
| Alcohol | 8 | 6.5 | 6.5 | 6.5 | 6.5 | 6.5 |
| ethoxylate 9EO | | | | | | |
| sodium alcohol | 8.66 | 5.5 | 0 | 8.6 | 7.6 | 8.6 |
| 3EO sulphate | | | | | | |
| coconut oil | 1 | 1 | 1 | 0 | 5.1 | 0 |
| fatty acid | | | | | | |
| amine oxide | 0 | 2 | 2 | 2 | 2 | 2 |
| (Ammonyx | | | | | | |
| 810DO) | | | | | | |
| sodium alkyl | 0 | 4 | 0 | 0 | 0 | 3 |
| sulphate | | | | | | |
| sodium alcohol | 0 | 0 | 10 | 0 | 0 | 0 |
| 1EO sulphate | | | | | | |
| Oleic acid | 0 | 0 | 0 | 3 | 0 | 0 |
| Total Active | 22.17 | 22 | 22 | 26.18 | 26.28 | 26.18 |

| | SRI |
|---|---|
| | polyester |
| Formulation | Red Clay |
| Example 1 | 56.59 |
| Example 2 | 57.41 |
| Example 3 | 57.28 |
| Example 4 | 60.2 |
| Example 5 | 57.98 |
| Example 6 | 57.27 |

### CONCLUSIONS

Addition of amine oxide gives benefit on particulate soil removal (Examples 1-3)
Combination with oleic acid provides further enhancement over SDS, and Oleic acid is better than coconut fatty acid in combination with amine oxide.
   Section 2: Addition of amine oxide: Comparison of combination with isosteric acid, SLES 1EO and SLES 3EO.

Addition of amine oxide to detergent base comparison
of isosteric acid with SLES 1EO and SLES 3EO

| | Wt % in formulation | | | | |
|---|---|---|---|---|---|
| | (minors and water to 100%) | | | | |
| | Exam- | Exam- | Exam- | Exam- | Exam- |
| Ingredient | ple 7 | ple 8 | ple 9 | ple 10 | ple 11 |
| linear alkyl | 4.1 | 4.1 | 4.1 | 4.1 | 4.1 |
| benzene | | | | | |
| sulphonate | | | | | |
| Alcohol | 6.5 | 6.5 | 6.5 | 6.5 | 6.5 |
| ethoxylate 9EO | | | | | |
| sodium alcohol | 7 | 0 | 0 | 7 | 0 |
| 3EO sulphate | | | | | |
| sodium citrate | 3 | 3 | 3 | 3 | 3 |
| amine oxide | 0 | 2 | 2 | 2 | 1 |
| (Ammonyx | | | | | |
| LO) | | | | | |
| sodium alkyl | 0 | 0 | 0 | 0 | 0 |
| sulphate | | | | | |
| sodium alcohol | 0 | 7 | 7 | 0 | 7 |
| 1EO sulphate | | | | | |
| isostearic acid | 0 | 0 | 1.5 | 1.5 | 0 |
| sodium borate | 3 | 3 | 3 | 3 | 3 |
| pentahydride | | | | | |
| triethanolamine | 1 | 1 | 1 | 1 | 1 |
| Coronase | 0.25 | 0.25 | 0.25 | 0.25 | 0.25 |
| Stainzyme | 0.1 | 0.1 | 0.1 | 0.1 | 0.1 |
| Total Active | 24.95 | 26.95 | 28.45 | 28.45 | 25.95 |

| | | SRI | | |
|---|---|---|---|---|
| | SRI | cotton | SRI | SRI |
| | polyester | Red | polyester | cotton |
| Formulation | Red Clay | Clay | Mud | Mud |
| Form 7 | 59 | 57.58 | 86.68 | 84.09 |
| Form 8 | 59.95 | 58.06 | 86.94 | 84.8 |
| Form 9 | 62.23 | 58.92 | 86.77 | 84.73 |
| Form 10 | 61.76 | 58.95 | 86.71 | 84.48 |
| Form 11 | 59.29 | 57.72 | 86.12 | 82.85 |

### CONCLUSION

Benefit from addition of amine oxide.
Combination with isosteric acid preferred.

### CONCLUSION

Overall performance indicated by PI. Preferred level in 8:4:1 Anionic: non-ionic: amine oxide
   Section 3: Effect of combination of amine oxide with branching in Non-ionic chain

Effect of branching on non- ionic chain
Ethylan 1005 (C7-C3 EO5)
Neodol 15 (C12 EO5)

| | Total active | |
|---|---|---|
| | concentration in the | |
| | wash = 1 g/l | |
| | Wt ratio of actives | |
| Ingredient | Base 1 | Base 2 |
| sodium alkyl sulphate | 8 | 8 |
| alcohol ethoxylate | 4 | 0 |
| (Ethylan 1005) | | |
| alcohol ethoxylate | 0 | 4 |
| (Neodol 15)) | | |
| Amine oxide (Empigen | 1 | 1 |
| OB) | | |

| | | SRI | SRI |
|---|---|---|---|
| Stain | Fabric | Base 1 | Base 2 |
| Red Clay | cotton | 63.63 | 63.49 |
| Face Makeup | cotton | 86.95 | 80.68 |
| Mud | cotton | 81.88 | 77.60 |
| Yellow pottery Clay | cotton | 83.15 | 80.56 |
| Red Clay | polyester | 71.60 | 68.15 |
| Face Makeup | polyester | 99.37 | 99.63 |
| Mud | polyester | 86.74 | 86.99 |
| Yellow pottery Clay | polyester | 95.32 | 94.10 |

### CONCLUSION

Benefit on particulate soil of combination with branched non-ionic.

1. Use of a detergent composition comprising an amine oxide surfactant, at least one branched nonionic surfactant and at least one anionic component for enhancing particulate soil removal from a fabric washed in a wash liquor containing the detergent composition.

2. Use according to claim 1, wherein the at least one anionic component is selected from anionic detersive surfactants, fatty acids, salts of fatty acids and mixtures thereof.

3. Use according to claim 2, comprising a fatty acid and/or a salt thereof which comprises at least 17 carbon atoms.

4. Use according to claim 2, wherein the fatty acid and/or salt thereof is or are selected from saturated and monounsaturated C₁₇-C₁₈ fatty acids and their salts.

5. Use according to claim 2, wherein the fatty acid and/or salt thereof is or are selected from oleic acid and isostearic acid and their salts.

6. Use according to claim 2, wherein the anionic detersive surfactants is or are selected from (poly)alkoxylated alkyl sulphate surfactants.

7. Use according to claim 6, wherein the (poly)alkoxylated alkyl sulphate surfactants comprise ethoxylated sulphates having from 1 to 3 ethyleneoxide units per molecule.

8. Use according to claim 1, wherein the detergent composition is a liquid detergent composition, preferably an aqueous liquid detergent composition.

9. Use according to claim 1, wherein the amine oxide has the general formula (I):—
R¹R²(N)R³→0 (I)
wherein R¹ and R² are independently C₁-C₄ alkyl or hydroxyl-C₁-C₄ alkyl groups and R³ is a C₈ to C₁₈ alkyl or alkenyl group.

10. A detergent composition comprising an amine oxide surfactant, at least one branched nonionic surfactant and at least one fatty acid or salt thereof having at least 17 carbon atoms.

11. A detergent composition according to claim 10, wherein the fatty acid and/or salt thereof is or are selected from saturated and monounsaturated C₁₇-C₁₈ fatty acids and their salts.

12. A detergent composition according to claim 10, wherein the fatty acid and/or salt thereof is or are selected from oleic acid and isostearic acid and their salts.

13. A detergent composition according to claim 10, comprising from 0.1% to 10%, preferably from 0.5% to 5% by weight of the total composition of the amine oxide surfactant.

14. A detergent composition according to claim 10, comprising from 0.5% to 15%, preferably from 1% to 10% by weight of the composition of the fatty acid and/or fatty acid salt.

15. A detergent composition according to claim 10, in the form of a liquid detergent composition, preferably an aqueous liquid detergent composition.

16. A detergent composition according to claim 10, wherein the amine oxide has the general formula (I):—
R¹R²(N)R³→0 (I)
wherein R¹ and R² are independently C₁-C₄ alkyl or hydroxyl-C₁-C₄ alkyl groups and R³ is a C₈ to C₁₈ alkyl or alkenyl group.
